(19) United States
(12) Patent Application Publication
(10) Pub. No.: US 2008/0049202 A1
(43) Pub. Date: Feb. 28, 2008

(54) PROJECTION EXPOSURE APPARATUS FOR SEMICONDUCTOR LITHOGRAPHY

(75) Inventor: Daniel Kraehmer, Aalen (DE)

Correspondence Address: FISH & RICHARDSON PC, P.O. BOX 1022, MINNEAPOLIS, MN, 55440-1022, US

(73) Assignee: CARL ZEISS SMT AG, Oberkochen (DE)

(21) Appl. No.: 11/842,319

(22) Filed: Aug. 21, 2007

(30) Foreign Application Priority Data
Aug. 22, 2006 (DE) 10 2006 039 215.9

(51) Int. Cl. G03B 27/52

(52) U.S. Cl. 355/30

(57) ABSTRACT

The disclosure relates to a projection exposure apparatus for semiconductor lithography comprising optical elements and at least one sensor for determining the temperature of regions of at least one optical element. In this case, at least one temperature regulating element is provided and the at least one sensor is arranged in the edge region of the at least one optical element.

### CROSS-REFERENCE TO RELATED APPLICATION

This application claims priority under 35 U.S.C. §119 to corresponding German Patent Application No. 10 2006 039 215.9, filed on Aug. 22, 2006, which is incorporated by reference herein.

### FIELD

The disclosure relates to projection exposure apparatuses for semiconductor lithography, as well as related systems, components and methods.

### BACKGROUND

A projection exposure apparatus for semiconductor microlithography typically includes optical elements.

### SUMMARY

In one aspect, the disclosure generally provides an apparatus that includes optical elements, at least one sensor, and at least one temperature regulating element. The at least one sensor is configured to determine a temperature of regions of at least one of the optical element. The at least one temperature regulating element configured to be temperature regulated so that the temperature of the regions of the at least one of the optical elements can be matched to one another. The at least one sensor is arranged in an edge region of the at least one of the optical elements. The apparatus is a projection exposure apparatus configured to be used in semiconductor lithography.

In another aspect, the disclosure generally provides to a method that includes determining a temperature of regions of at least one optical element of a projection exposure apparatus. The method also includes regulating a temperature of the at least one optical element. The at least one optical element is configured to be temperature regulated so that the temperature of the regions is matched to one another. The determination of the temperature is made by at least one sensor arranged in an edge region of the at least one optical element.

In some embodiments, the disclosure provides a device and a method which allow the temperature profile of arbitrary optical elements arranged in a projection objective for semiconductor lithography to be determined and regulated with sufficient accuracy.

In some embodiments, the projection exposure apparatus for semiconductor lithography includes optical elements, such as lenses or mirrors, and at least one sensor for determining the temperature of regions of at least one of the optical elements and at least one temperature regulating element. In this case, the at least one optical element is temperature-regulable in such a way that the temperature of the regions can be matched to one another and the at least one sensor is arranged in the edge region of the at least one optical element. In this case, the direct arrangement of the sensor in the edge region of the optical element can have the advantage that the information about the temperature distribution in the optical element can be obtained directly at the location without any significance being attached to the restrictions mentioned in the introduction from the limited accessibility of the optical elements to be measured. The arrangement of the sensor in the edge region of the optical element can permit the thermal conditions to be determined virtually in each optical element of the projection exposure apparatus without the occurrence of conflicts with those regions of the optical elements to which the electromagnetic useful radiation is applied. Further, the information about the temperature distribution in the respective optical element of interest can be obtained directly and not by model derivation from the imaging properties of the projection exposure apparatus, such that errors based on inaccuracies or errors of the model used can be precluded from the outset. Errors which can adversely affect the imaging properties of the projection exposure apparatus can be reduced (e.g., eliminated) at the locations at which they arise. This can allow for relatively fast, relatively efficient correction of the errors can become.

The optical element can be, for example, a lens or a mirror. The lens or the mirror can have a substantially circular cross section and the at least one sensor can be, for example, arranged at the circumference of the lens or mirror. In some embodiments, a plurality of sensors are arranged at substantially identical angular distances along the circumference. As an example, four sensors can be arranged at an angular distance of approximately 90°. As another example, eight sensors can be arranged at an angular distance of 45°. As a further example, sixteen sensors can be arranged at an angular distance of 22.5°. Intermediate values or larger or smaller numbers of sensors are also possible. The spatial resolution of the temperature measurement along the circumference of the optical element typically will increase with the number of sensors. The outlay for making electrical contact may also rise with the number of sensors.

In certain embodiments, at least one temperature regulating element is arranged in the region of a sensor, such that the regulated local temperature regulation of the optical element is made in the region in which the present temperature is recorded. Optionally, the sensor and the temperature regulating element can be a combined element. This can allow the entire arrangement to be constructed in a relatively simple manner (e.g., by saving structural space).

Peltier elements can be used as temperature regulating elements. Peltier elements can optionally be used both for heating and for cooling the structure connected to them. It can be possible to change from heating operation to cooling operation in a simple manner by changing the polarity of the voltage present at the Peltier element. The desired functionality (heating or cooling) can be adapted merely via the driving of the Peltier element.

The basic functioning of a Peltier element can permit the Peltier element to be used as a sensor. This can be achieved based on the fact that a voltage is present on account of the Seebeck effect at different metals that are joined to one another, as is the case in the Peltier element, as reaction to a temperature gradient arising at the metal stack. In this operating mode, the Peltier element can act as a thermopile or as a thermoelement. The Peltier elements can thus be used as heating, cooling or sensor elements merely by changing the electrical driving or by tapping off the voltage present at them.

The use of Peltier elements as a sensor can allow a sensor to be formed and arranged at the optical element in such a way that it is suitable for measuring temperature gradients along the circumference of the optical element. For this purpose, for example in the case of a lens as optical element, the Peltier element can be arranged at the circumferential surface of the lens in such a way that the stacking direction of the different materials used in the Peltier element runs in the direction of the circumference of the lens. If a temperature gradient forms along the circumference of the lens at the location of the Peltier element, it can immediately be detected from the voltage supplied by the Peltier element as a sensor. Afterwards, using the same Peltier element as a temperature regulating element, it is possible to set the desired temperature distribution at the circumference of the lens in a relatively efficient manner. A temperature gradient can optionally be detected just by the use of a single sensor. The desired distribution can optionally be set in a relatively efficient manner on account of the dual effect of the Peltier element (heating on the one hand and cooling on the other). Other appropriate sensors or temperature regulating elements suitable for measuring or generating temperature gradients can be used, such as, for example, fibre Bragg grating sensors or other optical fibre sensors (e.g., because of the desirable small structural space).

A wide variety of conceivable heating and cooling elements can be used for the temperature regulation of the optical element. It is also possible for the optical element as a whole to be permanently heated or cooled and for it to be locally cooled or heated as desired. In some embodiments, the application of ohmic heat via a resistance heating element (e.g., a heating wire) and/or irradiation with electromagnetic radiation (e.g., infrared radiation) can be used.

Various possible desired temperature distribution can optionally be set along the circumference of the optical element. In some embodiments, the desired temperature distribution can be distinguished by the fact that it is homogeneous along the circumference of the optical element (no or only very small temperature gradients arise along the circumference of the optical element). It is also possible to regulate the temperature distribution at the circumference of the optical element to the effect that on average a temperature gradient that is as small as possible is established across the entire optical element. For this purpose, the temperature distribution along the circumference of the optical element need not necessarily be homogeneous. The temperatures to be set at the circumference can depend on the intensity distribution of the optical radiation across the optical element and also on the heat conducting properties of the optical element itself.

It can be advantageous if for the definition of the parameters for the temperature regulation a theoretical model is used which incorporates parameters (e.g., the geometry of the optical element, the material properties of the optical element, the intensity distribution of the illumination of the optical element in the projection exposure apparatus). It is possible to ensure an enhanced (e.g., optimum) driving of the temperature regulating elements using the data supplied by the sensors. The theoretical model can also use information about the structure on the reticle in order to improve the prediction accuracy.

It can be advantageous to be able to set the temperature at the circumference of the optical element precisely in the region of approximately 0.01 K.

As an alternative or in addition it may be provided that the temperature regulation is effected in such a way that time-dependent changes in the temperature of the optical element are reduced. The temperature of the optical element can thus kept relatively constant during the operation of the semiconductor lithography apparatus. A—spatially homogeneous—temperature change of the optical element may result in rotationally symmetrical imaging aberrations, which are usually corrected via lenses that can be displaced along the optical axis. If the average temperature of the optical element is then also kept as constant as possible over time, this can ultimately reduce the need to take countermeasures via the displaceable lenses mentioned above, whereby the overall outlay for reducing (e.g., minimizing) the image aberrations resulting from thermal effects is considerably reduced.

The procedure in this case can be such that the temperature regulation and the determination of the temperature are effected alternately for example using a combined element composed of sensor and temperature regulating element, such as a Peltier element for example. By way of example, the Peltier element is operated firstly as a temperature sensor in the manner of a thermopile and the temperature presently prevailing at the location of the sensor is determined in this way. Afterwards—depending on the desired target temperature—the Peltier element is driven in such a way that it has a heating or cooling effect. This can be achieved in a simple manner by the choice of the polarity of the connection.

In certain embodiments, all the sensors and/or temperature regulating elements can be arranged in the edge region of the at least one optical element.

Optionally, the optical element can be arranged near the pupil. A positioning of the optical element in the vicinity of an image plane, in particular an intermediate image plane, is also conceivable. The optical element can be formed for example as the last optical element in the beam path of the projection exposure apparatus in the vicinity of the field.

Features and advantages of the invention are in the description, drawings and claims.

### BRIEF DESCRIPTION OF THE DRAWINGS

FIG. 1 shows a projection exposure apparatus for semiconductor lithography.

FIG. 2 shows an optical element with sensors.

### DETAILED DESCRIPTION

In general, a projection exposure apparatus for semiconductor microlithography can be used with a variety of electromagnetic radiation, such as, for example, in the visible range, the UV range or the EUV range. The radiation is typically used to project the image of a reticle (commonly referred to as a mask) onto a semiconductor wafer coated with photoresist and in this way to create the structures of a semiconductor component to be produced if appropriate in a plurality of exposure steps in conjunction with further process steps, such as etching and development for example. To modify the illumination properties of the projection exposure apparatus and to image the reticle on the wafer, different optical elements (e.g., lenses and/or mirrors) are provided in objectives in the projection exposure apparatus. During the operation of the projection exposure apparatus, the optical elements usually have the electromagnetic radiation applied to them with a specific intensity distribution, which depends in particular on the choice of the angular distribution of the light used for illumination, the so-called illumination settings, and also on the geometrical structure of the reticle. Often, some of the electromagnetic radiation is absorbed by the optical elements, which can result in local heating of individual regions of the optical elements. Such heating can lead to a change in the refractive index in conjunction with expansion of the material and also mechanical stresses and thus to the impairment of the imaging properties of the optical elements used and, as a result, of the quality of the image projected onto the wafer. The temperature distribution in the optical elements can be decomposed into rotationally symmetrical components and components having azimuthal undulations. The azimuthal undulations can result from the geometry of the scanner slot in the case of step-and-scan systems, for example, such that the intensity conditions in the scanning direction and orthogonally thereto are different. This symmetry breaking in the field can lead to two-wave temperature distributions in the vicinity of field planes. Furthermore, the dipole illumination that is increasingly used for enhancing the resolution has the effect that strongly two-wave temperature distributions occur in particular in optical elements in the vicinity of the pupil planes. A similar effect can be triggered by the use of a reticle having line structures predominantly in the horizontal direction; in this case, the distribution of the intensity of the diffracted light in the pupil predominantly has contributions in the vertical direction.

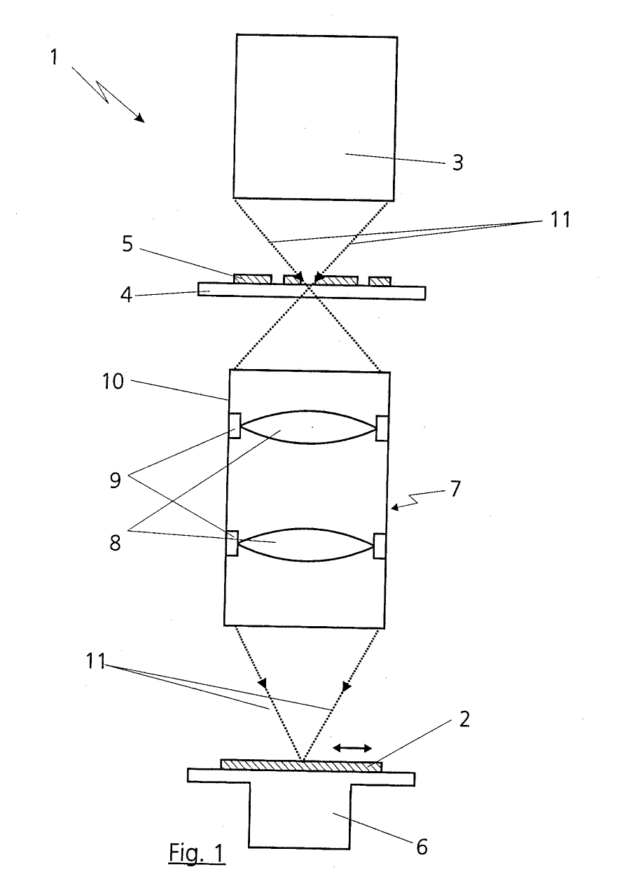

FIG. 1 illustrates a projection exposure apparatus 1 for semiconductor lithography into which the optical elements described are integrated. This apparatus serves for exposing structures onto a substrate coated with photosensitive materials, which substrate generally predominantly includes silicon and is referred to as wafer 2, for producing semiconductor components, such as e.g. computer chips.

The projection exposure apparatus 1 includes an illumination device 3, a device 4 for receiving and exactly positioning a mask provided with a structure, a so-called reticle 5, which determines the later structures on the wafer 2, a device 6 for mounting, moving and exactly positioning precisely the wafer 2, and an imaging device, namely a projection objective 7, including a plurality of optical elements 8 which are held via mounts 9 in an objective housing 10 of the projection objective 7.

In this case, the basic functional principle provides for the structures introduced into the reticle 5 to be imaged onto the wafer 2; the imaging is generally performed in demagnifying fashion.

After an exposure has taken place, the wafer 2 is moved further in the arrow direction, such that a multiplicity of individual fields, each having the structure predetermined by the recticle 5, are exposed on the same wafer 2. On account of the step-by-step advancing movement of the wafer 2 in the projection exposure apparatus 1, the latter is often also referred to as a stepper.

The illumination device 3 provides a projection beam 11 used to image the reticle 5 on the wafer 2, for example light or a similar electromagnetic radiation. A laser or the like can be used as a source for this radiation. The radiation is shaped in the illumination device 3 via optical elements in such a way that the projection beam 11, upon impinging on the reticle 5, has the desired properties with regard to diameter, polarization, shape of the wavefront and the like.

Via the beams 11, an image of the reticle 5 is generated and transferred to the wafer 2 in correspondingly demagnified fashion by the projection objective 7, as has already been explained above. The projection objective 7 has a multiplicity of individual refractive, diffractive and/or reflective optical elements such as e.g. lenses, mirrors, prisms, terminating plates and the like. In this case, the optical elements 8 are provided with sensors and can be arranged at any desired locations in the projection objective.

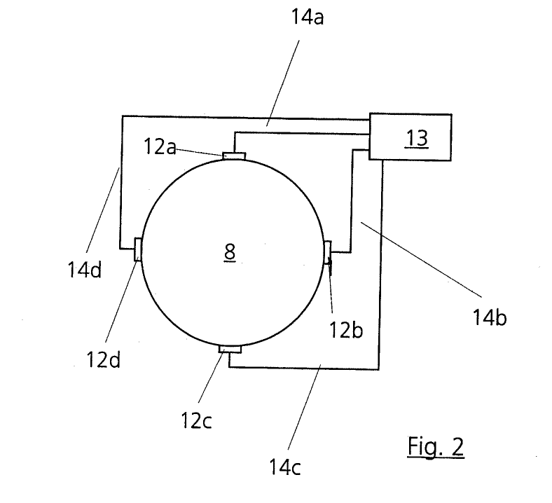

FIG. 2 shows an optical element 8, which is formed as a lens having a substantially cylindrical edge in the present case. The four Peltier elements 12a to 12d are arranged along the lateral cylinder surface of the optical element 8. In this case, the Peltier elements 12a to 12d are arranged at substantially identical angular distances of approximately 90°. The control unit 13 is connected to the Peltier elements 12a to 12d via the signal lines 14a to 14d. It regulates on the basis of the measured values detected by the Peltier elements 12a to 12d as sensors, signal strength and polarity of the voltage applied to the respective Peltier elements 12a to 12d. In this case, the control unit 13 can be formed as a microcomputer, in particular, into the main memory of which is loaded a computer program adapted to the circumstances of the respective optical element 8.

Other embodiments are in the claims.

What is claimed is:

1. An apparatus, comprising:
optical elements;
at least one sensor configured to determine a temperature of regions of at least one of the optical elements; and
at least one temperature regulating element configured to be temperature regulated so that the temperature of the regions of the at least one of the optical elements can be matched to one another,
wherein the at least one sensor is arranged in an edge region of the at least one of the optical elements, and the apparatus is a projection exposure apparatus configured to be used in semiconductor lithography.

2. The apparatus according to claim 1, wherein the at least one of the optical elements comprises a lens or a mirror having a substantially circular cross section.

3. The apparatus according to claim 2, wherein the at least one sensor is arranged at a circumference of the at least one of the optical elements.

4. The apparatus according to claim 3, comprising a plurality of sensors arranged at substantially identical angular distances along the circumference of the at least one of the optical elements.

5. The apparatus according to claim 1, wherein the at least one of the optical elements has an outer surface in the shape of a lateral surface of a cylinder, and the at least one sensor is on the outer surface of the at least one of the optical elements.

6. The apparatus according to claim 1, wherein the at least one temperature regulating element is in the region of the at least one sensor.

7. The apparatus according to claim 1, wherein the at least one sensor and the at least one temperature regulating element are a combined element.

8. The apparatus according to claim 1, wherein the at least one temperature regulating element is a Peltier element.

9. The apparatus according to claim 1, wherein the at least one sensor is disposed at the at least one of the optical elements so that the at least one sensor is configured to measure temperature gradients along a circumference of the at least one of the optical elements.

10. The apparatus according to claim 1, wherein at least member selected from the group consisting of the at least one sensor and the at least one temperature regulating element is in the edge region of the at least one of the optical elements.

11. The apparatus according to claim 1, wherein the at least one of the optical elements is arranged near a pupil of the apparatus.

12. The apparatus according to claim 1, wherein the at least one of the optical elements is in the vicinity of an image plane of the apparatus.

13. The apparatus according to claim 12, wherein the at least one of the optical elements is the last optical element in a beam path of the apparatus.

14. A method, comprising:
determining a temperature of regions of at least one optical element of a projection exposure apparatus; and
regulating a temperature of the at least one optical element,
wherein the at least one optical element is configured to be temperature regulated so that the temperature of the regions is matched to one another, and the determination of the temperature is made by at least one sensor arranged in an edge region of the at least one optical element.

15. The method according to claim 14, wherein the at least one of the optical elements is a lens or a mirror having a substantially circular cross section.

16. The method according to claim 15, wherein the at least one sensor is in the region of the circumference of the at least one of the optical elements.

17. The method according to claim 14, wherein the determination of the temperature is made for different regions of the at least one of the optical elements.

18. The method according to claim 14, wherein the temperature regulation is made so that a substantially homogeneous temperature distribution results across the entirety of the at least one of the optical elements.

19. The method according to claim 18, wherein a theoretical model is used to regulate the temperature.

20. The method according to claim 19, wherein the theoretical model incorporates at least one parameter selected from the group consisting of material properties of the at least one of the optical elements and an intensity distribution of the illumination of the at least one of the optical elements in the apparatus.

21. The method according to claim 14, wherein the temperature regulation and the determination of the temperature are performed alternately using at least one combined element composed of the at least one sensor and the temperature regulating element.

22. The method according to claim 14, wherein the temperature regulation is made so that time-dependent changes in the temperature of the at least one of the optical elements are reduced.

23. The method according to claim 14, wherein at least one member selected from the group consisting of the at least one sensor and the temperature regulating elements is in the edge region of the at least one of the optical elements.

24. The method according to claim 14, wherein the at least one of the optical elements is near a pupil of the apparatus.

25. The method according to claim 14, wherein the at least one of the optical elements is in the vicinity of an image plane of the apparatus.

26. The method according to claim 25, wherein the at least one of the optical elements is the last optical element in a beam path of the apparatus.
